(19) United States
(12) Patent Application Publication
(10) Pub. No.: US 2006/0070179 A1
(43) Pub. Date: Apr. 6, 2006

(54) Hand and foot bath liners with solution bubble

(76) Inventor: Carolyn L. Siegal, Los Angeles, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 10/956,447

(22) Filed: Oct. 1, 2004

(51) Int. Cl. A47K 3/022; A61H 35/00; E03C 1/00

(52) U.S. Cl. 4/622

(57) ABSTRACT

A hand or foot bath liner with solution bubble is formed from a flexible plastic sheet. The sheet has an elastic member attached to its surrounding perimeter to secure the liner to the surrounding rim of a hand or foot bath tub. A solution bubble is attached to the upper surface of the plastic sheet and contains a solution for use in the hand or foot bath. The solution bubble is formed of planar flexible material and forms an enclosed space between its bottom surface and the upper surface of the plastic sheet. When the bubble is pierced, the solution will be released into the liner. To aid in piercing or opening the bubble, the solution bubble may have a weakened area, pull strip or weakened edge with or without pull tab. The solution bubble is used to enclose a quantity of skin softener, astringent, fragrance solution, disinfectant, and other emollients.

### FIELD OF INVENTION

The invention pertains to sanitary devices for use in the provision of manicures and pedicures. More particularly, the invention relates to flexible liners for use with soaking tubs designed to prevent contamination of patrons from unsanitary soaking tubs.

### BACKGROUND OF THE INVENTION

Manicures and pedicures have been provided professionally for many years in beauty parlors, hair salons and in dedicated nail establishments. In order to provide for neat and efficient cutting of nails and cuticles, service providers typically have customers soak their hands or feet in a solution intended to warm and soften the nails and cuticles. This is typically done in hand or foot soaking tubs. Due to the popularity of these services, problems have developed with contamination of the soaking tubs by those having various nail and cuticle related diseases. If the tubs are not cleaned carefully between uses, it is easy for a subsequent customer to be infected by a prior one. Nail infections, in particular, are painful and difficult to eradicate, and often discolor the nail. To eliminate this problem, a variety of tub liners have been developed.

U.S. Patent Application No. 2003/0155260, published by Mailhart et al., describes a disposable footbath and handbath liner with or without herbal scents. This device includes a sheath/insert/liner that is a single sheath/sheet of thin yet tough, flexible, waterproof, material that may be of any suitable or desirable shape and size and specifically fits the general contour as the inner contour of the footbath. The walls of the sheath/insert/liner preferably should snuggly conform or adhere to the sides of the footbath. The inside of the sheath/insert/liner can be part of kit that includes a pouch having herbs, salts, or oils to be used during the foot/hand treatment. The pouch can include tear off tabs allowing the herbal scents/salts/oils to dissipate in the water.

U.S. Pat. No. 6,662,398, issued to Thomson, discloses a hands free foot scrubber. This device includes a bath mat of a suitable non-porous flexible plastic material such as vinyl that is placed lengthwise on the floor at the head of the bathtub. The upper surface includes two spaced raised footpads at the forward end of the mat. Each pad includes a plurality of upwardly extending soft bristles, preferably formed of a suitable durable resilient plastic material such as vinyl, and outlet openings for liquid soap. The underside of the mat with the footpad areas having separable soap containers or bladders of pliable tear resistant polyurethane or propylene filled with liquid soap fitting within the space below the pads. An alternative construction includes a single soap bladder. The bladder includes a plurality of ridged tubular connectors on the upper surface having openings that fit closely and engage similarly shaped slightly larger outlets in the footpad to release liquid soap through openings. This occurs when subject to foot pressure of the individual scrubbing feet on the bristles of the upper pad surface. The bladder may contain about ounces of soap.

U.S. Pat. No. 4,820,435, issued to Zafiroglu, discloses a liquid-dispensing pouch. This device includes an internal chamber of the pouch that is filled with a liquid that can pass through a non-woven wall of the pouch when the outside of the wall is wetted by a solvent for the liquid within the pouch. If the liquid inside the chamber is an aqueous solution, then wetting the outside of the non-woven wall with water permits the aqueous solution to pass through the non-woven wall and be dispensed from the pouch. A variety of liquids can be employed in the liquid-dispensing pouches of the invention. Generally, the liquids have a Brookfield viscosity in the range of 5 to 50,000 centipoise. Liquids, particularly aqueous liquids, having viscosities in the range of 10,000 to 35,000 cp are preferred. Aqueous solutions of soap are especially preferred.

U.S. Pat. No. 3,851,340, issued to Keusch, describes a plastic container for a footbath. This device includes a footbath container that further includes an interior portion. The interior portion comprises two separate feet receptacles, and a mixing cavity at the top end of the container. The mixing cavity is separated from the foot receptacles by separator walls and respectively. Please kindly note that in operation, the components of a foot bathing mixture, including water or some other fluid, are placed in the mixing cavity and mixed as required. After the mixture has been thus prepared, the container is tilted by raising the top end of the container with the bottom end of the container being used as a pivot point. As more fluid exits from the channel, the fluid will overflow the edges of the wall and flow into the cavities and. In this manner, the entire contents of the cavity can be emptied into the cavities so that the footbath mixture can be prepared in the container and then distributed into the feet receptacles. When the fluid has been distributed in the feet receptacles, the user's feet are placed in the receptacles with the toes facing the top end of the container.

U.S. Pat. No. 3,174,654, issued to Reiner, discloses a dispensing package with a resilient block. This device or container includes a pair of flat, flexible opposing walls that are adapted to hold a quantity of powder or other like material to be dispensed. The walls are held together by a continuous peripheral edge seam so as to seal the interior space of the container. Optionally, to facilitate the dispensing of the powder, opposing diagonal score lines are formed in the respective walls. The score lines extend diagonally across the peripheral seam and also across a portion of the walls located interiorly of seam. The score line defines a tear-off corner outwardly of the score line, which may be torn off from the rest of the container along the score line to define an opening between the walls and to the outside. In use, after the tear-off corner is removed to expose the opening, the container may be grasped between fingers with the fingers registering with the end faces of the block. Fingers may be used to the press walls against the end faces so as to compress the block and thereby expel some of the powder through the opening.

It is an objective of the present invention to provide a system for insuring that the solution used in had and foot soaking tubs is not contaminated by prior customers. It is a further objective to provide hand and foot bath liners that will fit snugly to tubs of various sizes. It is a still further objective of the invention to provide a bubble or solution pack integral with the tub liner. Finally, it is an objective to provide tub liners that are non-porous, easy to empty and inexpensive to produce.

While some of the objectives of the present invention are disclosed in the prior art, none of the inventions found include all of the requirements identified.

### SUMMARY OF THE INVENTION

The present invention addresses all of the deficiencies of prior art had and foot bath liner inventions and satisfies all of the objectives described above.

(1) A hand bath liner with solution bubble providing the desired features may be constructed from the following components. A flexible plastic sheet is provided. The sheet has an upper surface, a lower surface and a surrounding perimeter. An elastic member is provided. The elastic member is attached to the plastic sheet adjacent the surrounding perimeter. A solution bubble is provided. The solution bubble is attached to the upper surface of the plastic sheet and contains a solution. When the elastic member is stretched over a surrounding rim of a hand bath, the liner will be secured to it and when the solution bubble is pierced, the solution will be located within the liner.

(2) In a variant of the invention, the perimeter is folded inwardly to secure the elastic member to the plastic sheet.

(3) In another variant, the solution bubble is a section of flexible planar material. The material has a top surface, a bottom surface, a surrounding edge and forms an enclosed space between the bottom surface and the upper surface of the plastic sheet.

(4) In still another variant, the solution bubble includes a weakened area in the top surface, so that the solution bubble may be more easily pierced to release the solution.

(5) In yet another variant, the weakened area includes a pull strip. The pull strip permits easy opening of the solution bubble.

(6) In still another variant, a portion of the surrounding edge is removably attached to the upper surface of the plastic sheet.

(7) In a further variant, the surrounding edge includes a pull tab. The pull tab permits easy separation of the surrounding edge from the plastic sheet.

(8) In still a further variant, the solution is selected from the group consisting of skin softener, astringent, fragrance solution, disinfectant, and other emollients.

(9) In another variant of the invention, a foot bath liner with solution bubble, includes a flexible plastic sheet. The sheet has an upper surface, a lower surface and a surrounding perimeter. An elastic member is provided. The elastic member is attached to the plastic sheet adjacent the surrounding perimeter. A solution bubble is provided. The solution bubble is attached to the upper surface of the plastic sheet and contains a solution. When the elastic member is stretched over a surrounding rim of a foot bath, the liner will be secured thereto and when the solution bubble is pierced, the solution will be located within the liner.

(10) In still another variant, the perimeter is folded inwardly to secure the elastic member to the plastic sheet.

(11) In yet another variant, the solution bubble is a section of flexible planar material. The material has a top surface, a bottom surface, a surrounding edge and forms an enclosed space between the bottom surface and the upper surface of the plastic sheet.

(12) In a further variant, the solution bubble includes a weakened area in the top surface, so that the solution bubble may be more easily pierced to release the solution.

(13) In still a further variant, the weakened area includes a pull strip. The pull strip permits easy opening of the solution bubble.

(14) In yet a further variant, a portion of the surrounding edge is removably attached to the upper surface of the plastic sheet.

(15) In still another variant, the surrounding edge includes a pull tab. The pull tab permits easy separation of the surrounding edge from the plastic sheet.

(16) In a final variant of the invention, the solution is selected from the group consisting of skin softener, astringent, fragrance solution, disinfectant, and other emollients.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a hand bath with a liner of the present invention installed;

FIG. 2 is a perspective view of the liner of the FIG. 1 embodiment;

FIG. 3 is a plan view of the FIG. 1 embodiment illustrating the solution bubble;

FIG. 4 is a cross-sectional view of the FIG. 1 embodiment taken along the line 4-4;

FIG. 5 is a plan view of the FIG. 1 embodiment illustrating a solution bubble with weakened areas;

FIG. 6 is a plan view of the FIG. 1 embodiment illustrating a solution bubble with a pull tab; and

FIG. 7 is a perspective view of a foot bath with a liner of the present invention installed.

### DETAILED DESCRIPTION OF THE PREFERRED EMBODIMENT

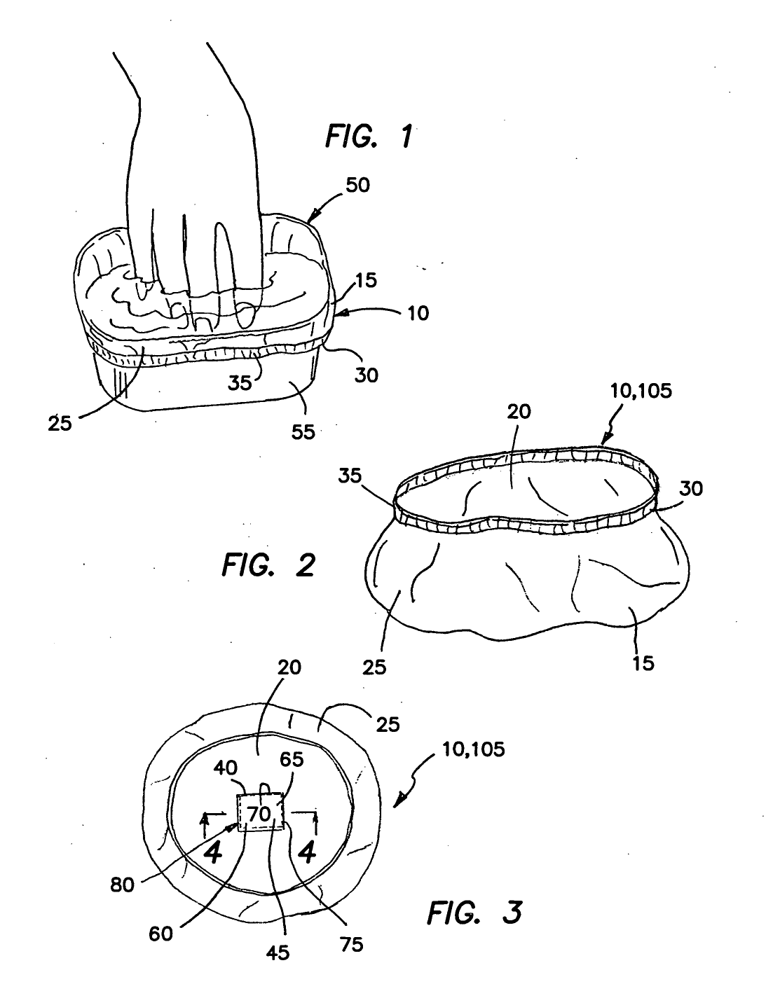

(1) FIGS. 1-6 illustrate a hand bath liner with solution bubble 10 providing the desired features that may be constructed from the following components. A flexible plastic sheet 15 is provided. The sheet 15 has an upper surface 20, a lower surface 25 and a surrounding perimeter 30. An elastic member 35 is provided. The elastic member 35 is attached to the plastic sheet 15 adjacent the surrounding perimeter 30. A solution bubble 40 is provided. The solution bubble 40 is attached to the upper surface 20 of the plastic sheet 15 and contains a solution 45. When the elastic member 35 is stretched over a surrounding rim 50 of a hand bath 55, the liner 10 will be secured to it and when the solution bubble 40 is pierced, the solution 45 will be located within the liner 10.

(2) In a variant of the invention, as illustrated in FIGS. 1 and 2, the perimeter 30 is folded inwardly to secure the elastic member 35 to the plastic sheet 15.

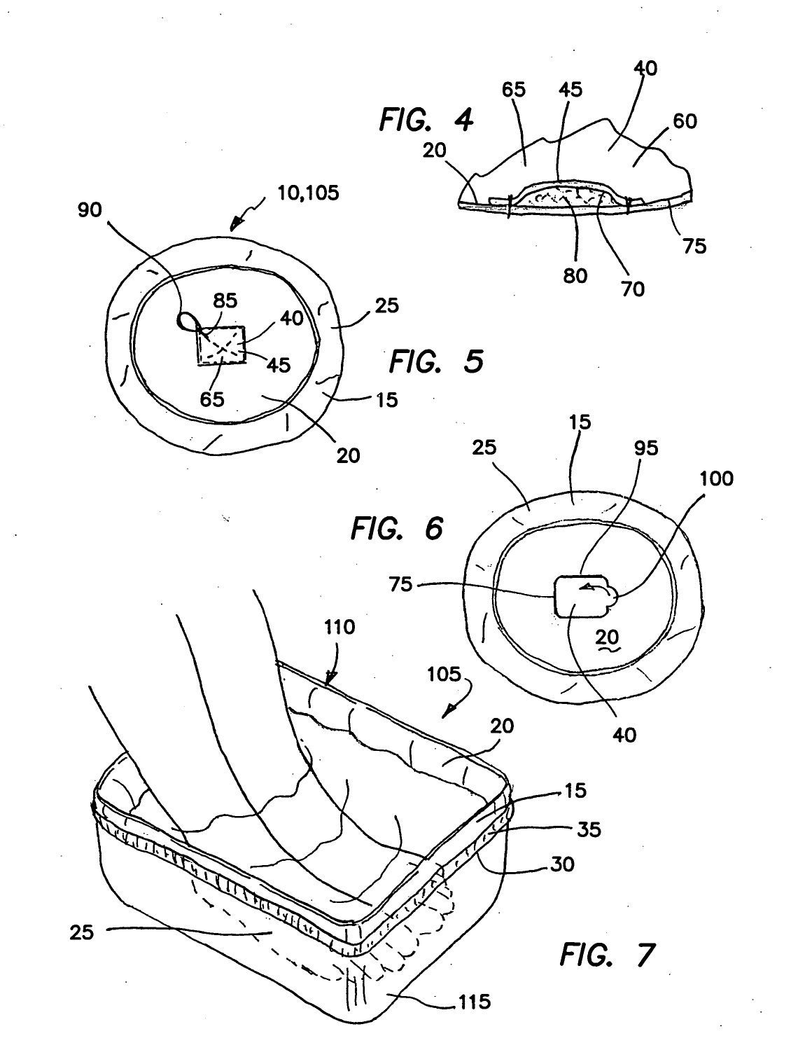

(3) In another variant, as illustrated in FIGS. 3 and 4, the solution bubble 40 is a section of flexible planar material 60. The material 60 has a top surface 65, a bottom surface 70, a surrounding edge 75 and forms an enclosed space 80 between the bottom surface 70 and the upper surface 20 of the plastic sheet 15.

(4) In still another variant, as illustrated in FIG. 5, the solution bubble 40 includes a weakened area 85 in the top surface 65, so that the solution bubble 40 may be more easily pierced to release the solution 45.

(5) In yet another variant, as illustrated in FIG. 5, the weakened area 85 includes a pull strip 90. The pull strip 90 permits easy opening of the solution bubble 40.

(6) In still another variant, as illustrated in FIG. 6, a portion 95 of the surrounding edge 75 is removably attached to the upper surface 20 of the plastic sheet 15.

(7) In a further variant, as illustrated in FIG. 6, the surrounding edge 75 includes a pull tab 100. The pull tab 100 permits easy separation of the surrounding edge 75 from the plastic sheet 15.

(8) In still a further variant, the solution 40 is selected from the group consisting of skin softener, astringent, fragrance solution, disinfectant, and other emollients.

(9) In another variant of the invention, as illustrated in FIGS. 2-7, a foot bath liner with solution bubble 105, includes a flexible plastic sheet 15. The sheet 15 has an upper surface 20, a lower surface 25 and a surrounding perimeter 30. An elastic member 35 is provided. The elastic member 35 is attached to the plastic sheet 15 adjacent the surrounding perimeter 30. A solution bubble 40 is provided. The solution bubble 40 is attached to the upper surface 20 of the plastic sheet 15 and contains a solution 45. When the elastic member 35 is stretched over a surrounding rim 110 of a foot bath 115, the liner 105 will be secured thereto and when the solution bubble 40 is pierced, the solution 45 will be located within the liner 105.

(10) In still another variant, as illustrated in FIGS. 2 and 7, the perimeter 30 is folded inwardly to secure the elastic member 35 to the plastic sheet 15.

(11) In yet another variant, as illustrated in FIGS. 3 and 4, the solution bubble 40 is a section of flexible planar material 60. The material 60 has a top surface 65, a bottom surface 70, a surrounding edge 75 and forms an enclosed space 80 between the bottom surface 70 and the upper surface 20 of the plastic sheet 15.

(12) In still another variant, as illustrated in FIG. 5, the solution bubble 40 includes a weakened area 85 in the top surface 65, so that the solution bubble 40 may be more easily pierced to release the solution 45.

(13) In yet another variant, as illustrated in FIG. 5, the weakened area 85 includes a pull strip 90. The pull strip 90 permits easy opening of the solution bubble 40.

(14) In still another variant, as illustrated in FIG. 6, a portion 95 of the surrounding edge 75 is removably attached to the upper surface 20 of the plastic sheet 15.

(15) In a further variant, as illustrated in FIG. 6, the surrounding edge 75 includes a pull tab 100. The pull tab 100 permits easy separation of the surrounding edge 75 from the plastic sheet 15.

(16) In a final variant of the invention, the solution 45 is selected from the group consisting of skin softener, astringent, fragrance solution, disinfectant, and other emollients.

The hand bath liner 10 and foot bath liner with solution bubble 105 have been described with reference to particular embodiments. Other modifications and enhancements can be made without departing from the spirit and scope of the claims that follow.

1. A hand bath liner with solution bubble, comprising:
a flexible plastic sheet, said sheet having an upper surface, a lower surface and a surrounding perimeter;
an elastic member, said elastic member being attached to said plastic sheet adjacent said surrounding perimeter;
a solution bubble, said solution bubble being attached to said upper surface of said plastic sheet and containing a solution; and
whereby, when said elastic member is stretched over a surrounding rim of a hand bath, said liner will be secured thereto and when said solution bubble is pierced, said solution will be disposed within said liner.

2. The hand bath liner with solution bubble, as described in claim 1, wherein said perimeter is folded inwardly to secure said elastic member to said plastic sheet.

3. The hand bath liner with solution bubble, as described in claim 1, wherein said solution bubble is a section of flexible planar material having a top surface, a bottom surface, a surrounding edge and forming an enclosed space between said bottom surface and said upper surface of said plastic sheet.

4. The hand bath liner with solution bubble, as described in claim 3, wherein said solution bubble further comprises a weakened area in said top surface, whereby said solution bubble may be more easily pierced to release said solution.

5. The hand bath liner with solution bubble, as described in claim 4, wherein said weakened area further comprises a pull strip, said pull strip permitting easy opening of said solution bubble.

6. The hand bath liner with solution bubble, as described in claim 3, wherein a portion of said surrounding edge is removably attached to said upper surface of said plastic sheet.

7. The hand bath liner with solution bubble, as described in claim 6, wherein said surrounding edge further comprises a pull tab, said pull tab permitting easy separation of said surrounding edge from said plastic sheet.

8. The hand bath liner with solution bubble, as described in claim 1, wherein said solution is selected from the group consisting of:
skin softener, astringent, fragrance solution, disinfectant, and other emollients.

9. A foot bath liner with solution bubble, comprising:
a flexible plastic sheet, said sheet having an upper surface, a lower surface and a surrounding perimeter;
an elastic member, said elastic member being attached to said plastic sheet adjacent said surrounding perimeter;
a solution bubble, said solution bubble being attached to said upper surface of said plastic sheet and containing a solution; and
whereby, when said elastic member is stretched over a surrounding rim of a foot bath, said liner will be secured thereto and when said solution bubble is pierced, said solution will be disposed within said liner.

10. The foot bath liner with solution bubble, as described in claim 9, wherein said perimeter is folded inwardly to secure said elastic member to said plastic sheet.

11. The foot bath liner with solution bubble, as described in claim 9, wherein said solution bubble is a section of flexible planar material having a top surface, a bottom surface, a surrounding edge and forming an enclosed space between said bottom surface and said upper surface of said plastic sheet.

12. The foot bath liner with solution bubble, as described in claim 11, wherein said solution bubble further comprises a weakened area in said top surface, whereby said solution bubble may be more easily pierced to release said solution.

13. The foot bath liner with solution bubble, as described in claim 12, wherein said weakened area further comprises a pull strip, said pull strip permitting easy opening of said solution bubble.

14. The foot bath liner with solution bubble, as described in claim 11, wherein a portion of said surrounding edge is removably attached to said upper surface of said plastic sheet.

15. The foot bath liner with solution bubble, as described in claim 14, wherein said surrounding edge further comprises a pull tab, said pull tab permitting easy separation of said surrounding edge from said plastic sheet.

16. The foot bath liner with solution bubble, as described in claim 9, wherein said solution is selected from the group consisting of:
skin softener, astringent, fragrance solution, disinfectant, and other emollients.
